(19) United States
(12) Patent Application Publication
(10) Pub. No.: US 2020/0110196 A2
(43) Pub. Date: Apr. 9, 2020

(54) DECISION-MAKING SUPPORT METHOD FOR ISSUING WARNINGS AND SELECTION OF MITIGATION ACTIONS PARAMETERIZED BY WEATHER-CLIMATE DECISION INDEX BASED ON USER PREFERENCES

(71) Applicants: INSTITUTO TECNOLÓGICO DE AERONÁUTICA - ITA, São José dos Campos (BR); INSTITUTO DE AERONÁUTICA E ESPAÇO - IAE, São José dos Campos (BR)

(72) Inventors: Amaury Caruzzo, São Paulo (BR); Mischel Carmen Neyra Belderrain, São Paulo (BR); Gilberto Fernando Fisch, São José dos Campos (BR)

(21) Appl. No.: 16/334,295

(22) PCT Filed: Sep. 19, 2016
(86) PCT No.: PCT/BR2016/050232

§ 371 Date: Mar. 18, 2019

(51) Int. Cl. G01W 1/10

(52) U.S. Cl. CPC G01W 1/10

(57) ABSTRACT

A decision-making support method is presented for issuing warnings and selecting mitigation actions parameterized by the turn of weather and/or climate information into a single decision index. A decision-making support method was developed from the Global Weather Decision Index (WDI) or Climate Decision Index (CDI), which is based on user preferences in relation to three characteristics of weather-climate information: a) value of the weather-climate variable; b) probability of occurrence; and c) lead-time of weather-climate information. The presented embodiments were initially developed having as the field of application the area of aerospace meteorology, as motivation the rockets launch operations in space centers. However, the decision-making process under weather uncertainty is relevant in other applications where weather or climate conditions may cause some kind of impact on activities.

### CROSS-REFERENCE TO RELATED APPLICATIONS

This application is a national stage application of international patent application number PCT/BR2016/050232, filed on Sep. 19, 2016, which is hereby incorporated by reference in its entirety.

### TECHNICAL FIELD

The present patent refers to a decision-making support method for issuing warnings and for mitigation actions selection parameterized by the change of meteorological and/or climatic information into a single weather decision index, or even climate decision index. The present invention was initially developed having a field of application the area of aerospace meteorology, as motivation the rocket launch operations in space centers. However, the decision-making process under weather uncertainty is relevant in other applications, such as agriculture, aviation, energy systems, natural disasters, and so on, where weather or climate conditions can cause some kind of impact, disruption, damage or impairment in activities.

### BACKGROUND

With a focus on climate change and the risks of extreme weather events, several processes in the scientific literature and patent documents seek to integrate forecasting of atmospheric conditions with approaches to decision analysis. However, the meteorological and/or climatic forecast usually has a large variation in the probabilities of occurrence, considering the different lead-time (hours, days, months or years) and the values of the atmospheric variables forecast, characterizing as a complex decision-making process.

Currently, the decision-making process for issuing warnings in cases of extreme weather and/or climatic events is based on fixed and pre-defined thresholds by official governmental organizations. However, the preferences of the several users regarding the consequences of the decision under weather or climatic uncertainty should be incorporated into the decision-making process. That is, users have different attitudes according to the probabilities of environmental predictions, which also has a variability over the lead-time considered. In addition, the risks associated with weather or climate conditions are interpreted differently by users, according to individual perception.

The decision-making process for issuing warnings and selecting mitigation actions in the event of extreme weather and/or climatic events can cause major impacts and a high-cost for society. In these situations, it is necessary to identify the best mitigation alternatives for disaster risk reduction, infrastructures protection and safeguarding human lives. It is noteworthy that the weather and climate conditions have effects not only during extreme events, but also in everyday activities. On the other hand, the impacts of a natural meteorological-climatological disaster on the various human activities can be as significant as the impacts of a terrorist act or a technological accident.

### DESCRIPTION OF THE PRIOR ART

The decision-making process under uncertain conditions is something that is recurrent and widely debated in the scientific literature and other patent documents. On the other hand, interaction with users has often shown that existing traditional approaches are not capable of incorporating the decision-making context related to the weather-climate prediction information. That is, these procedures are not adequate when user preferences are dynamic and change over a given lead-time information. For example, a strong wind forecast with 80% probability and with a 1-hour lead-time, the user has a different behavior towards the same forecast, but with a 2-days term. As previously mentioned, another feature of weather-climate information is that the probabilities have great variability over the forecast lead-time. In this perspective, the impacts and consequences are different, and the user has to continually judge the different probabilities and terms in order to evaluate the best decision.

Over the last decades the quality of weather and climate forecasting has significantly improved. On the other hand, despite the development of computational systems and new techniques of atmosphere observation, this type of environmental forecast still has -uncertainty, because the atmosphere is a chaotic and non-linear system. Currently, the weather-climate forecast uses as one of the main tools numerical modeling of the atmosphere. Using mathematical calculations, the forecast can be considered: a) deterministic, when the simulation is executed only once, or; b) probabilistic, when techniques are applied to estimate the probability of occurrence of the expected atmospheric parameters. Using statistical methods or numerical simulations convergence, it is possible to establish a Probabilistic Prediction (PP), where the value of each weather-climate variable is associated with an expiry date and a probability of occurrence. With PP, meteorologists, users and decision makers can assess the possible consequences and the respective levels of confidence about the forecast information. From the users' point of view, PP also allows identifying the risk profile and the behavior towards the odds in the case of adverse weather-climate conditions.

The construction of an operational decision-making process from weather-climate information that has uncertainty must be developed together with the end-users. Therefore, it is necessary to establish procedures and model the structure of judgments from the user perspective, in order to understand the decision-making context and identify the perception and behavior of those involved. In this way, user preferences in relation to weather-climate information are established and incorporated into the decision-making support system.

In this sense, several patents have procedures to aid a decision using environmental information. To facilitate the understanding, a description of the prior art will be presented in two groups: 1) information providers/receivers systems, equipment and methods to support decision making; 2) methods and procedures in the development of decision-making support systems.

About the first group, we have several patents filed in Brazil describing environmental data acquisition systems. For example, patent documents PI9403267-0 A, PI0904147-8 A2, PI1001765-8 A2 and PI1103479-3 A2 present environmental data acquisition systems, whether or not they relate to the issue of warnings. In these patent documents, the equipment is installed in pre-determined locations with the objective of making real-time observations of the various meteorological and environmental variables. Observations are processed and transmitted through a communication system to the users. Processing and transmission may include issuing warnings provided that the value of the environmental variable is above a certain level.

EP1192612 B1 discloses a device and method for receiving weather warnings employing various communication means, such as cellular network, radio, wireless network, among others. In this work, it is necessary to establish in advance an organization responsible for the transmission of messages and warnings.

ES2281887 T3 relates to equipment to be installed in a given region for monitoring rains and floods. After reaching a pre-set level the instrument automatically issues warnings to the users.

Another widely used approach to assisting decision making using meteorological information is the construction of specific indexes and/or categories classification based on the perception of non-expert users. In the development of these indices the values of observed and/or predicted environmental variables can be used. As an example, U.S. Pat. No. 7,251,579 B2 proposes a method for determining a “thermal comfort” index which considers various meteorological parameters. US20030126155 A1 describes a method for transforming climatological data into an index for derivatives and insurance companies. That is, the index aims to aid the decision-making process with reference to only observed and unanticipated data. US20140039832 A1 develops a method for calculating an energy index as a function of environmental conditions. The objective is to estimate the thermal demand in buildings from heating systems.

In categories classification patents, we initially have US20120047187 A1 which refers to a natural disaster management system. With the application of a computer program, several categories of data (meteorological, geological, population, so on.) are used to support decision making in case of extreme events in emergency response. User preferences are built-in by weighting among the several categories of data (criteria) and by calculating a multi-criteria index.

U.S. Pat. No. 7,191,064 B1 which develops a method for issuing warnings using the construction of a weather risk scale (severity level) based on user preferences, classified by activity type and geographic region. US20070225915 A1 describes a method for classifying extreme weather events (hurricanes in North America) by multiple environmental criteria. Impacts are estimated with the elaboration of scenarios and corresponding mitigation plans.

Regarding the second group of Patents, where structures of decision-making support systems are presented, we initially have PI0806035-5 A2 which refers to a decision-making support system that incorporates the cognitive characteristics of users in relation to strategic aspects. That is, it establishes the profile of the decision makers about relevant criteria in the organizations planning.

A highly referenced patent document is U.S. Pat. No. 5,870,730. It describes the theoretical structure of a method and rules for automatic decision-making (autonomous systems) based on a scale of users' preferences in relation to the decision-making context. It is noteworthy that in the presented method, the probability distribution and the alternatives are previously defined. U.S. Pat. No. 5,940,816 describes a method for automatic decision making using linear programming with multi-objective functions. Several objectives are previously defined with the decision makers and then the optimal values for each of the objectives are determined. The best alternative is recommended based on multiple conditional alternatives defined previously by users. In U.S. Pat. No. 6,498,987 B1 and U.S. Pat. No. 6,018,699 A, systems are presented with a method of interaction with the users, which provides some criteria for receiving a weather forecast and/or personalized storm warnings through various communication means.

U.S. Pat. No. 6,631,362 B1 and U.S. Pat. No. 8,548,890 B2 show procedures for decision making under uncertainty using the principles of Utility Theory. That is, it establishes the criteria, the respective weights, the probability distribution of the alternatives and later determines the expected utilities according to the users' preferences. Another technique widely used in decision making under uncertainty is presented in U.S. Pat. No. 7,305,304 B2, which describes a method through a decision tree. In this work a probabilistic weather forecasting is used, and operational meteorological limits are defined to support the supply of fuels in commercial aircraft.

In patents focusing on decision-making processes in the event of severe events or natural disasters, we have U.S. Pat. No. 8,836,518 B2 showing a classification of meteorological severity according to levels (limits) previously defined by the users involved. A system that integrates geographic information and real-time observation is shown with the transmission of warnings by various means of communication. US20130132045 A1 describes a system of forecasting weather-related natural disasters, based on numerical models and data from a geographic information system. With an analysis of the various parameters and previous impact mapping, alert information is transmitted to the user.

U.S. Pat. No. 7,080,018 B1 describes a method and system using a computer program for activity planning based on adverse weather-climate information. Users' preferences are identified and through geographic information, personalized and automatic data are received, in order to support the decision for activities susceptible to environmental conditions.

EP1761906 B1 discloses a system for identifying the return time and probability of flood risk based on hydrological history, rainfall forecast and regional geographic information. It is also known U.S. Pat. No. 7,181,346 B1, which develops a system of issuing warnings by geographic areas, in cases of prediction of adverse weather events classified by activity, category and subject of interest previously defined by the user.

### Technical Problems Existing in the Prior Art

Among the patent documents identified in the field of information provider/receiver systems, equipment and methods to support decision making (PI 9403267-0 A; PI 0904147-8 A2; PI 1001765-8 A2; PI 1103479-3 A2; EP 1192612 B1 and ES2281887 T3) there is a scope restriction in relation to the point where the equipment is installed, since the sensors are locally housed. The systems operation is directly related to observational data and the approaches presented do not support decision and/or early warning issuing (forecasting). Also, the variations of warning levels in a variability condition of the information and/or the change of the observation lead-time are not quantified.

In patent documents having approaches in index development and categories classification (U.S. Pat. No. 7,251,579 B2; US20030126155 A1; US20140039832 A1; US20120047187 A1; U.S. Pat. No. 7,191,064 B1 and US20070225915 A1), it is possible to identify that the methods presented do not incorporate the potential behavior change of each user in relation to weather-climate conditions. Another limitation is that historical data or even real-time observations are applied, so it is not possible to apply the indexes/categories for weather forecasts (future events), and consequently without a decision-making application under uncertainty using forecasting.

A common deficiency observed in patent documents relating to approaches with generic decision-making support and/or warning issuing (PI 0806035-5 A2; U.S. Pat. Nos. 5,870,730; 5,940,816; 6,498,987 B1; U.S. Pat. Nos. 6,018,699 A and 7,181,346 B1) is in the not to quantify the variation impacts of the cognitive aspects in weather-climate uncertainty (user perception) and/or lead-time changes. That is, procedures are not established when there is a modification of users' preferences in relation to forecasts, or even, it is not demonstrated how the weights among the multiple criteria and/or objectives are incorporated. In these approaches there are other limitations such as fixed lead-time information and also they are not demonstrated procedures to adjust the warning issuing in relation to the different likelihoods of the weather-climate forecast.

In patent documents which applying classical approaches to decision-making under uncertainty (U.S. Pat. No. 6,631,362 B1, U.S. Pat. No. 8,548,890 B2 and U.S. Pat. No. 7,305,304 B2), which use the concept of utility and expected value (expectation of reward), the approaches presented are not entirely satisfactory for the decision-making context in question, since adequate procedures are not established in relation to the three characteristics of the weather-climate forecast (value, probability and lead-time). The methods do not consider the variability in the probabilities and uncertainties of the information throughout the analyzed period (all forecast lead-time). Another limitation is not to incorporate the respective changes in users' behavior to the values of the variable when changes occur in the same lead-time. As a consequence of these limitations, in these patents there is a need to continuously restructure the proposed systems to assimilate the variations in the values of the probability distributions over the lead-time considered. Only in this way could the new expected values of the alternatives be estimated for each lead-time. However, this is an operationally unfeasible process due to the characteristics of the weather-climate forecast.

In patent documents which develop solutions related to natural disasters and severe hydro-meteorological events (U.S. Pat. No. 8,836,518 B2; US20130132045 A1; U.S. Pat. No. 7,080,018 B1; EP1761906 B1) also have some limitations. In this group an approach is not established to incorporate probabilistic weather-climate forecasting (with percentage of occurrence) and/or are based only on historical data (past events). Therefore, it is not suitable for early decision making in situations of uncertainty using probabilistic forecasting. In this context, there would also be a need for a solution that demonstrates how users' preferences are about forecast conditions (value, probability, and lead-time) and how these attitudes should be incorporated to support operational decision making.

### SUMMARY

The great challenge to turn weather-climate information into a decision is to incorporate the structure of users' preference in relation to the characteristics of information. In other words, it is to identify an alternative choices that, in a given weather-climate condition, maximizes the user's expectation of reward.

In this context the present invention aims to develop a new technique to support the decision-making process under weather-climate uncertainty, considering the preferences of non-experts' users. That is, stockholders who do not have technical knowledge about the atmospheric sciences or climatology. For this, the Weather-Climate DecisionSupport Method (WCDSM) constructed from a new index, called the Weather Decision Index (WDI) or Climate Decision Index (CDI) is proposed. The WDI and CDI seek to solve the main limitation of the methods described above, which is to incorporate the perceptions and behaviors (preferences structures) of users concerning the three main characteristics of weather-climate information, being:

i. probability of occurrence of the weather-climate forecast (%)

ii. Lead-time information (hours, days, months, years)

iii. value of the variable considered (wind, rain, temperature, among others)

As an alternative solution, the “DECISION-MAKING SUPPORT METHOD FOR ISSUE WARNINGS AND MITIGATION ACTIONS SELECTION PARAMETERIZED BY WEATHER-CLIMATE DECISION INDEX BASED ON USER PREFERENCES” has been developed in the present Patent according to the users preferences entered in the decision-making context. The Weather Decision Index (WDI) or Climate Decision Index (CDI) is based on the concept of preference, that is, on the user's perception and attitude regarding the characteristics of the meteorological and/or climatic information, according to three parameters:

a) value of the weather and/or climate variable (called attribute); b) probability (estimate occurrence) of variable and; c) lead-time of the variable or meteorological and/or climatic information. It should be noted that in this document will be differentiated the use of the diagnosed information, in:

i. Weather: information with the real-time observation of the atmosphere and/or weather forecast with a term of few minutes (very short term) up to a maximum of a few days (usually 10 days);

ii. Climate: seasonal forecast (months), years and/or climate change scenarios (decades).

Thus, the term “weather-climate” will be adopted in this text.

From the interaction with the information users, the operating limits are identified; the table of weather-climate risk is constructed, the preferences by the perception and behavior concerning to weather-climate information are identified; the thresholds for issuing warnings and selecting potential mitigation actions are established in cases of adverse events.

### BRIEF DESCRIPTION OF DRAWINGS

To describe the technical solutions in the embodiments of the present application more clearly, the following briefly introduces the accompanying drawings required for describing the embodiments. The accompanying drawings in the following description show merely some embodiments of the present application.

FIGS. 1 and 2 show an overview of the development of the Weather-Climate Decision Support Method (WCDPM), with sequential steps using the Weather Decision Index (WDI) or Climate Decision Index (CDI).

FIG. 3 shows the dimensional space of the WDI or CDI function, where it is possible to identify the possible values of Equation 1 (WDI or CDIε[0.1]).

FIG. 4 is a flowchart of the general structure of the WCDSM using the WDI or CDI Function.

FIG. 5 shows the operational threshold defined by the user for the application example of this application, for each weather variable, for the probabilities and the weather forecast lead-time.

FIG. 6 is a table with the classification of the weather hazard levels (only for the value of the variable).

FIG. 7 illustrates the probability-related value function of the weather forecast for the application example of the present application.

FIG. 8 shows the value function relative to the weather forecast lead-time for the application example of the present application.

FIG. 9 shows the value function for the rain of the application example of the present application.

FIG. 10 illustrates the value function for the wind speed of the application example of the present application.

FIG. 11 shows the hierarchical structure of the decision problem with the two weather attributes (rain and wind) and the respective weights, for the application example of the present application.

FIG. 12 is a table with the classification of levels for issuing warnings in cases of adverse/extreme weather events in the application example of the present application.

### DETAILED DESCRIPTION OF THE EMBODIMENTS

Decision-making support method for issuing Warnings and Selection of Mitigation Actions parameterized by Weather-Climate Decision Index follows four (4) steps:

Step 1 (101): Decision Problem Structuring that uses the weather-climate information;

Step 2 (102): Construction of value functions, partial indexes and turns weather-climate information into a Global Decision Index (multi-attribute);

Step 3 (103): Development and parameterization of the Weather-Climate Decision Support Method (WCDSM); and

Step 4 (104): Results and recommendations, the step of which may comprise:

a) Levels for issuing warnings (105); and/or

b) Selection of mitigation actions/portfolios (106).

Step 1 (101) comprises three (3) sub-steps: a) Interviews with actors, stakeholders and decision makers (201); b) Identification of vulnerabilities, risks and impacts (202); c) Definition of variables (attributes) and operational thresholds (203).

Step 2 (102) also comprises three (3) sub-steps: a) Construction of the value functions of weather-climate information characteristics and calculation of partial weather-climate decision indices (204); b) Construction of weights among weather variables (205); c) Calculation of global or multi-attribute Weather Decision Index (WDI) or Climate Decision Index (CDI) (206).

Step 3 (103), comprises three (3) sub-steps: a) Definition of scenarios of adverse weather-climate events (207); b) Identification of classes for issuing warnings and portfolio selection (mitigation actions) (208); c) Evaluation of performance in issuing warnings and selecting portfolios (209).

Finally, Step 4 (104), which comprises of two (2) situations: a) Issuance of warnings: Classification and recommendation for issuing warnings by weather-climate information (105); and b) Mitigation Portfolios: Classification and recommendation of mitigation actions by weather-climate information (106).

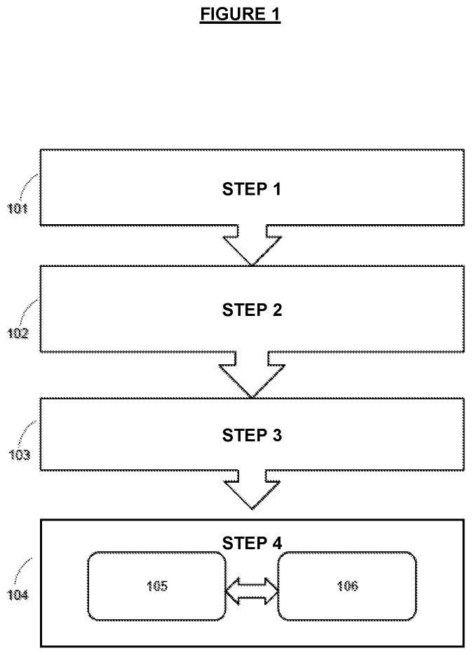

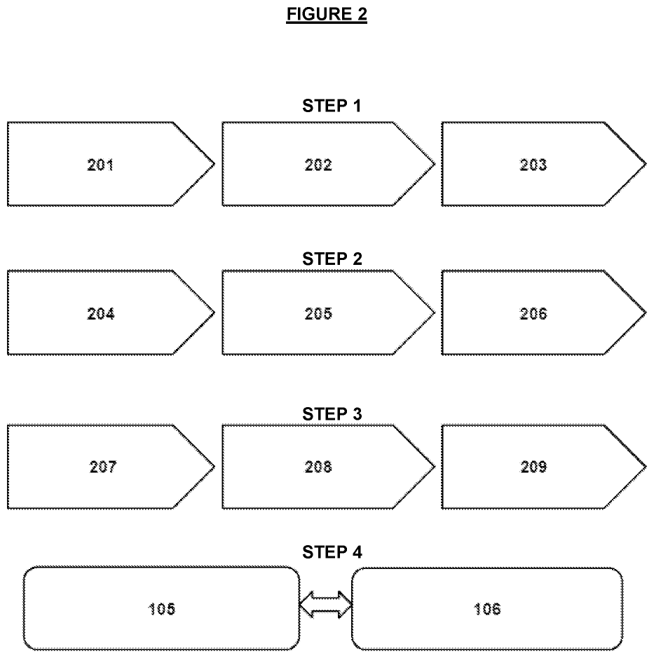

FIGS. 1 and 2 show the 4 steps of WCDSM development.

The following is a more detailed description of said steps.

Initially to establish preferences and model the structure of judgments, it is necessary interaction with the stakeholders/users involved in the decision-making context, considered as an initial structuring step of the problem (101). Based on users' personal or group interviews (201), all vulnerabilities, risks and their related impacts on weather-climate conditions (202) are identified. Next, the relevant weather variables, considered as the attributes of the decision model, are established and the levels of the operational thresholds (203) of these attributes are defined. This sub-step also identifies the user's preferences regarding the probabilities and lead-time of weather-climate information through their respective operational thresholds. These operational thresholds are divided into two categories: the first operational threshold (L₁), considered the ideal value, where for the user there is no restriction due to weather-climate conditions. Therefore, it is characterized as ‘best’ level (L₁=1). The second operational threshold (L₂) is the value that, despite adverse weather-climate conditions, can still be considered acceptable to the user, so that it will be considered as the ‘worst’ level (L₂=0). For the construction of the classification table of weather-climate hazards, a level of Intermediate operational threshold (L*) was defined, considering the value of the variable where the value function is equal to zero point five (average between L₁ and L₂, L*=0.5), as will be demonstrated in the application example of the present patent.

The second step is the process of changing weather-climate information into a decision index (102). The value functions for each characteristic of the information (probability, lead-time and of each selected variable) are constructed together with the user. In this process three distinct value functions are established which, aggregated into a single index, are called the partial Weather Decision Index (WDI) or partial Climate Decision Index (CDI) (204). These functions establish for the specific aspects of weather-climate information value on the scale [0,1], according to the user' behavior and profile. In the WCDSM it is defined that the anchor values for the construction of the functions are the operational thresholds (L) previously described. Among the anchor values, linear or more complex functions can be applied, such as logistic or exponential curves, to adequately represent the users' profile with the scale of [0,1].

The first partial value function that integrates the WDI or CDI function is related to the probability of the weather-climate (Iₚ) information. The second value function is in relation to the lead-time or time of the information (Iₜ). The third value function is related to the attributes, that is, the set of weather-climate variables selected by the user (Iₓ). For the construction of the WDI and/or CDI Function, some assumptions were adopted, which:

i. The preferences of the probabilities ‘p’ and the lead-time ‘t’ are the same for any variable ‘x’

ii. If I_{P} or Iₜ=0→wdi or cdi=1

iii. If I_{P} and Iₜ=1→wdi or cdi=Iₓ

iv. If I_{P} and Iₜ=1 and Iₓ=0→wdi or cdi=0

Therefore, the innovation of this patent is: being wdi or cdi=f (Iₚ, Iₜ, Iₓ) for every attribute ‘x’, from the aggregation into a single value is defined the function of partial Weather Decision Index (WDI) or Climate Decision Index (CDI) for each variable (attribute). According to the assumptions presented above, a general equation was developed for the decision index function for each specific attribute (Equation 1):

wdiₓ or cdiₓ=Iₓ+(1−Iₓ)(1−(IₚIₜ)^{ρ}) (1)

where:

wdiₓ or cdiₓ=weather-climate decision index for the attribute ‘x’

Iₓ=value function for the attribute (variable)

Iₚ=value function for the probability ‘p’ of the information

Iₜ=value function for the lead-time T of the information

ρ=adjustment parameter (=0.5)

FIG. 3 shows the dimensional space of the WDI or CDI Function, where it is possible to identify the possible values of Equation 1 (301) according to the lead-time information (303). It is also possible to observe the curves of the assumptions adopted ii (302) and iii (304).

In the change step (102), weights or attribute weights (205) are also identified, since the WDI or CDI is characterized as a multiple criteria decision, since there is more than one weather-climate attribute in the decision-making context. The weights can be determined by several methods (trade-off method, peer-to-peer comparison, swing weights, among others). In the application example of this Patent, it will be described in detail how determining the weights by one of these approaches.

For the development of the global WDI or CDI function, where all attributes (variables) are considered, the concepts of Multi-attribute Decision Analysis with single criterion of synthesis described in the books “Multiple Criteria Decision Analysis: An Integrated Approach”, by Belton and Stewart (2002); and “The Knowledge and Use of Multicriteria Decision Aid Methods”, by Adiel T. Almeida (2011) were applied. Therefore, the value of the global or multi-attribute WDI or CDI function (206) is defined, incorporating all weather-climate variables selected by the user.

Considering the weather-climate information set ‘t’ (observation+forecast) the global or multi-attribute WDI or CDI (or only DI) function was constructed from the comparison of the effects among the variables and can be determined by Equation 2:

DI(t)=Σₓ₌₁ⁿkₓdiₓ(t) (2)

where:

diⱼ(i) is the (partial) wdi or cdi value of each attribute ‘x’ in the condition ‘t’

kₓ is the attribute weights, where Σₓ₌₁ⁿkₓ=1

The global or multi-attribute WDI or CDI function is an additive value function that determines the total values of each weather-climate condition, in which the recommended to the user will be the option that obtains the numerical result according to the levels of warnings previously established (e.g.: severity class) and/or ranking of decision alternatives (e.g.: mitigation actions).

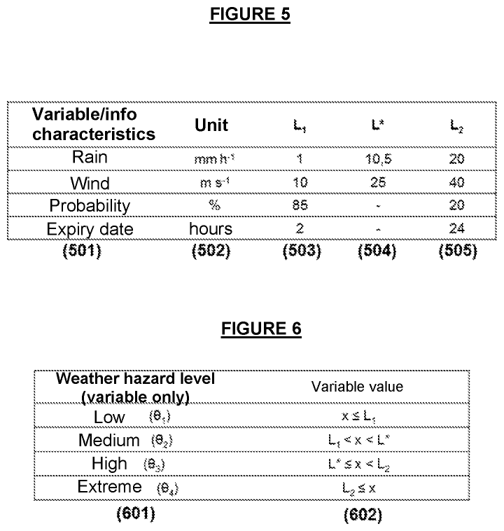

In the parameterizing step of the Weather-Climate Decision Support Method (WCDSM) (103), it is necessary to establish and classify the potential adverse weather-climate scenarios (207). The construction of scenarios can be performed from several approaches, such as the use of climatological data, event registration, scenario planning techniques, among others. In the WCDSM the scenarios are determined by varying the values of the attributes, defined by the level of weather hazards (FIG. 6). Once potential “weather-climate scenarios” have been established, it is possible to determine with the users the classification of warning levels and/or the respective decision alternatives. Using the variation of the values of the attributes and respectively of the minimum and maximum partial WDIs or CDIs for each scenario, the respective multi-attribute function values can be identified for each warning and/or alternative decision level (208). Subsequently, an evaluation of the results is performed using a Sensitivity Analysis (209), that is, to evaluate if the weights and results are robust. In the application example of this Patent, further details of the development and parameterization of the WCDSM will be presented.

The WCDSM proposal is to obtain two types of operational results: 1) decision support in the classification and issuance of adverse/extreme weather warnings (105); 2) decision support for classification and selection of mitigation actions (106). These applications are dependent on the decision-making context that uses weather-climate information and the specific users demands to the problematic situation. For example, the issuance of warnings in case of high-intensity rainfall in the short term has different characteristics in relation to the warnings to a dry season climate prediction for several months.

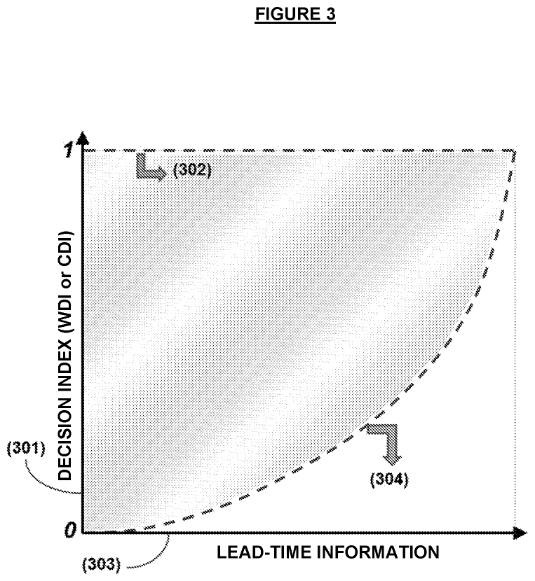

FIG. 4 shows the overall structure of the WCDSM proposal using the Weather Decision Index (WDI) or Climate Decision Index (CDI) of this Patent. The input information (401) can be entered into the system through several categories, including: real-time weather observations (402), weather forecast (up to 10 days) (403), climate prediction/prognosis (months) (404) and prediction related to climate changes (several years/decades) (405). From this information, the values of attributes (variables), information characteristics (406) and individually transformed (attribute ‘1’ (407), attribute ‘2’ (408) and attribute ‘n’ (409)) are evaluated in one of the value functions described above. From these value functions for each attribute, the partial WDI or CDI values can be calculated by Equation 1. The previously established weather-climate scenarios ‘S’ (417) and the respective warnings and/or decision alternatives (410) (mitigation action/warning level ‘1’ (411), mitigation action/warning level ‘2’ (412) and mitigation action/warning level ‘M’ (413)) are also incorporated in the system. From the partial WDI or CDI functions of each variable, the calculation of the multi-attribute WDI or CDI function is performed using Equation 2 (414). The WCDSM (414) presents the results, according to the user's preferences, and maybe the classification with different levels of warnings in case of adverse/extreme weather-climate conditions (recommendation in issuing category warnings in the lead-time the information) (105) and/or the classification for selection of mitigation portfolio (recommendation of mitigation actions in the lead-time information) (106).

Example of the Application

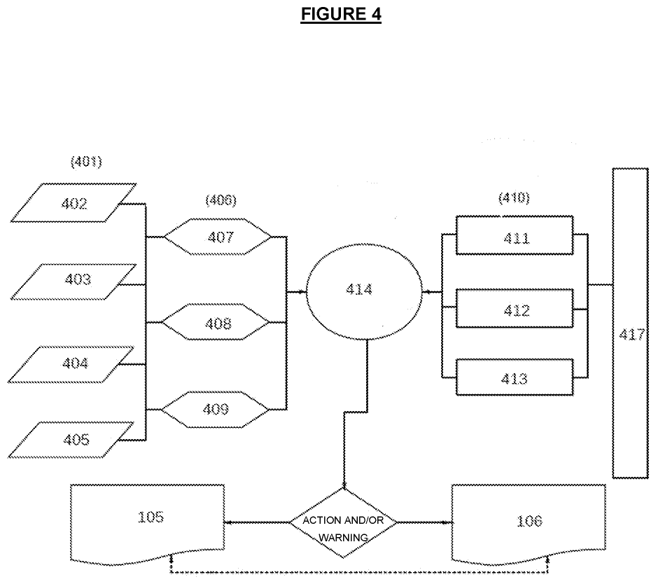

As way of demonstration (hypothetical example), a decision problem of issuing warnings for an extreme weather event will be used, using only two weather attributes (rain and wind). FIG. 5 shows the preferences indicated by a theoretical user about the operational threshold of the variables, probabilities and weather forecast lead-time (501), with the respective dimensional units (502). In column (503) are the ‘best’ threshold, or the ideal values. In column (505) are the ‘worst’ threshold when conditions are adverse but still acceptable to the user. Column (504) is the value L*, being valid only for the weather variables, as previously indicated.

FIG. 6 shows the weather hazard classification table, with four hazard levels (601) and respective value scales (602). Also, in Step 2 of transforming the weather forecast into an index, we have the first value function of this demonstration, related to the probability of the weather information. FIG. 7 shows the scale of the value function (Iₚ) from 0 to 1 (701) and the probability scale, 0% to 100% (702). Values above 85% are considered to be the ‘best’ level (=1) (705) and 20% is considered the ‘worst’ level (=0) (703). In this demonstration, a linear function was adopted between the two anchor values (704). The mathematical expression for the probability value function (p) is given in (706).

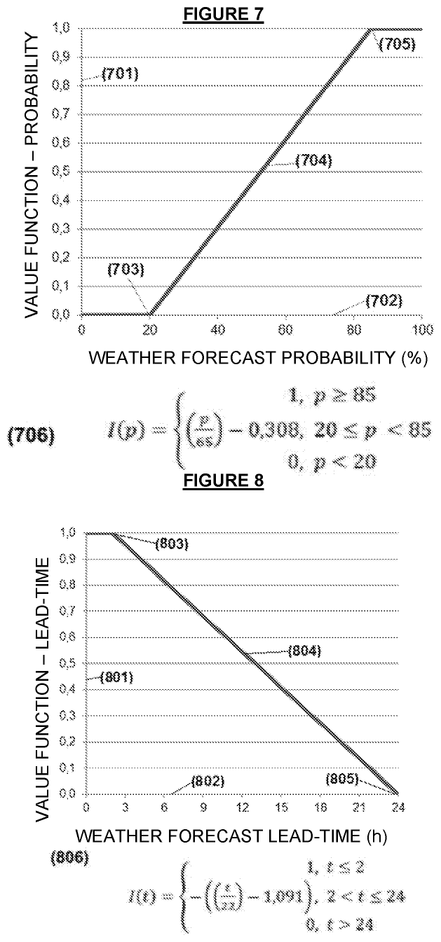

The second value function is in relation to the lead-time of the weather information. FIG. 8 shows the scale of the value function (801) of the weather forecast lead-time, from 0 to 24 hours (802) and the anchor values, being for the terms of up to 2 hours, is the ‘best’ (=1) (803) and above 24 hours, the ‘worst’ level (=0) (805). Also adopted a linear function between the two levels (804). The mathematical expression for the value function for the lead-time (t) is given in (806).

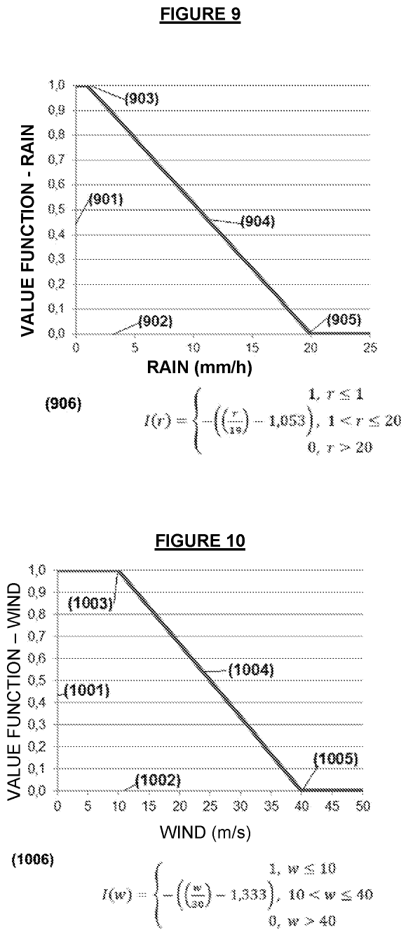

The value function for the rain attribute is shown in FIG. 9, according to the operational threshold previously defined in FIG. 5. Thus, we have the scale of (Iᵣ) (901), the precipitation value (902), the ‘best’ level (903), the ‘worst’ level (905) and the respective linear function (904). The mathematical expression for the rain value function (r) is given in (906). The function for the wind speed attribute is shown in FIG. 10, also according to the operational threshold previously defined in FIG. 5. We have the scale of (I_{w}) (1001), the wind speed (1002), the ‘best’ level (1003), the ‘worst’ level (1005) and the respective linear function between the two anchor values (1004). The mathematical expression for the wind speed value function (w) is given in (1006).

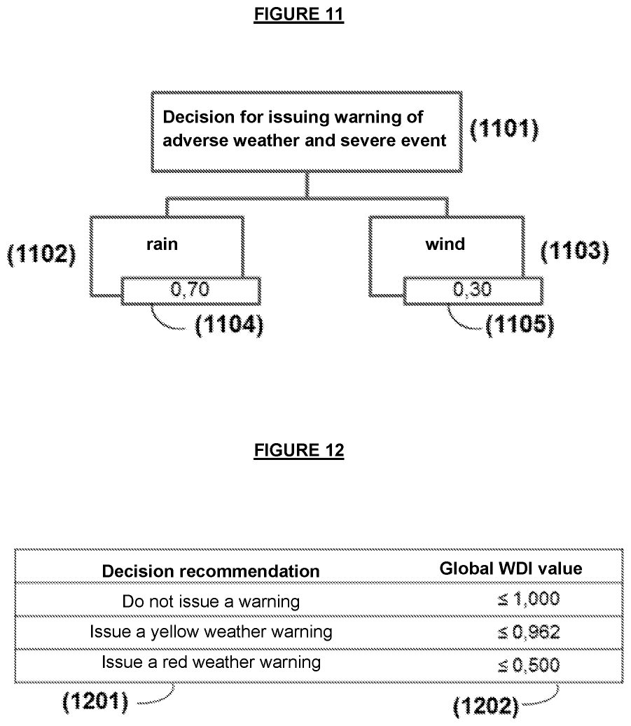

FIG. 11 illustrates the Hierarchical Structure between the two attributes, with the respective weights. In this demonstration, the decision problem is the issue of warnings (1101), considering the rain (1102), with a weight of 0.7 (1104) and the wind speed (1103), with a weight of 0.3 (1105). In order to identify the weights among the attributes in this demonstration, we used the Swing Weights approach, described in “Decision and Risk Analysis for the evaluation of Strategic Options” by Montibeller and Franco (2007) and also in “Treatment of uncertainty through the Interval Smart/Swing Weighting Method: a case study” by L. Gomes et al. (2011). This technique establishes a numerical index associated to the preferences among the attributes. That is, a way to determine the order of importance of the weather attributes, adopting a scale of value from 0 to 100, being the highest value the most important. The values in the scale are indicated for the different attributes, analyzing which is the preference for the user and establishing an equivalent value for the others, in relation to the first one. In this way, it is identified how much the user is prone to replace in one attribute to gain in another. Finally, once all the values in the scale for the attribute set have been established, the weight of each variable and the respective performances in each alternative are calculated.

From the variation in the values of the two attributes between the operational thresholds (FIG. 5), it is possible to question to the user what would be the decision if the weather scenario occurred for each of the levels of hazards (FIG. 6). In this demonstration, shown in FIG. 12, three levels of warning (1201) and the respective threshold for global WDI values (1202), according to the calculation using Equation 2.

As an illustration of the memory calculation of this demonstration, we have: the two attributes at the high weather hazard level (L*≤x<L₂), i.e. the rainfall between 10.5 and 20 mm/h and wind velocity between 25 and 40 m/s. It is considered a weather forecast with probability >85%, lead-time <2 h (hence we have Iₚ=1 and Iₜ=1) and the values of the two attributes equal to L*(r=10.5 mm/h=25 m/s). Using Equation 1, we determined the partial WDIs for each variable, with Iᵣ=0.5 and I_{w}=0.5. Therefore, the value of the Multi-attribute WDI Function according to Equation 2 and FIG. 11 will be WDI=0.5. Thus, in this demonstration, when the two attributes are at the high weather hazard level, the decision recommendation is to “issue a severe/extreme red warning” (FIG. 12).

Although some preferred embodiments of the present application have been described, persons skilled in the art can make changes and modifications to these embodiments once they learn the basic inventive concept. Therefore, the following claims are intended to be construed as to cover the preferred embodiments and all changes and modifications falling within the scope of the present application.

Obviously, persons skilled in the art can make various modifications and variations to the present application without departing from the spirit and scope of the present application. The present application is intended to cover these modifications and variations provided that they fall within the scope of protection defined by the following claims and their equivalent technologies.

1. The method for decision-making support for issuing warnings and selection of mitigation actions is characterized by the global weather-climate decision index and comprises four steps, these being:
step 1 (101): structure of the decision-making problem using weather-climate information;
step 2 (102): construction of value functions, partial indexes and turning weather-climate information into a Global Decision Index based on the users preferences regarding three characteristics of weather-climate information:
a) value of the weather-climate attribute;
b) probability of attribute occurrence; and
c) lead-time of weather-climate information;
step 3 (103): development and parameterization of the Weather-Climate Decision Support Method (WCDSM); and
step 4 (104): Results and Recommendations, this step comprising:
a) levels for issuing warnings (105); and/or
b) selection of mitigation actions/portfolios (106).

2. The method for decision-making support according to claim 1, characterized in that step 1 (101) is the initial problem structuring and comprises three sub-steps: a) Interviews with actors, stakeholders and decision makers (201); b) Identification of vulnerabilities, risks and impacts (202); c) Definition of attributes and operational thresholds (203).

3. The method for decision-making support according to claim 2, characterized in that the sub-step of Interviews with actors, stakeholders and decision makers (201) engages in interaction with the decision makers/users involved in the decision-making context to establish preferences and model the structure of judgments.

4. The method for decision-making support, according to claim 2, characterized in that in the sub-step of Identifying the vulnerabilities, risks and impacts (202) is performed from the personal or user groups interviews (201), identifications of all the vulnerabilities, risks and their respective impacts related to weather-climate conditions.

5. The method for decision-making support, according to claim 2, characterized in that the relevant weather variables, considered as the attributes of the decision-making model, are defined in the sub-step of Definition of the attributes and operational thresholds (203) and the operational threshold levels of these attributes are defined, as well as the user's preferences regarding the probabilities and lead-time of weather-climate information are identified through their respective operating thresholds.

6. The method for decision-making support according to claim 5, characterized in that said operational thresholds (L) are divided into two categories, being:
the first operational threshold L₁ characterized as the ‘best’ level (L₁=1); and
the second operational threshold L₂ characterized as the ‘worst’ level (L₂=0);
and for the construction of the weather-climate hazard classification table an intermediate operational threshold level (L*) was defined, considering the variable value where the value function is equal to zero point five (average between L₁ and L₂, L*=0.5).

7. The method for decision-making support according to claim 1, characterized in that in step 2 (102) the partial value functions of the information characteristics are constructed together with the user, step 2 comprising three sub-steps: a) Construction of the value functions of weather-climate information characteristics and calculation of partial weather-climate decision indexes (204); b) construction of weights between attributes (205); c) calculation of the global Weather Decision Index (WDI) or Climate Decision Index (CDI) (206).

8. The method for decision-making support according to claim 7, characterized in that in the sub-step of Construction of the partial Weather-Climate Decision Index functions (204) are established from three distinct value functions which, aggregated into a single index, called partial Weather Decision Index (WDI) or partial Climate Decision Index (CDI). These functions establishing for the specific aspects of weather-climate information a value on the scale [0,1], according to the user profile and behavior, being defined that the anchor values for the construction of the functions are the operational threshold (L).

9. The method for decision-making support according to claim 8, characterized in that the three functions are:
partial value function integrating the function of the Weather Decision Index (WDI) or Climate Decision Index (CDI) related to the probability of the weather-climate information (Iₚ);
partial value function integrating the function of the Weather Decision Index (WDI) or Climate Decision Index (CDI) related to the lead-time of the information (Iₜ);
partial value function integrating the function of the Weather Decision Index (WDI) or Climate Decision Index (CDI) related to the set of weather-climate attributes selected by the user (Iₓ).

10. The method for decision-making support according to claim 9, characterized in that the weather-climate decision index for the attribute ‘x’ (wdiₓ or cdiₓ); value function for attribute ‘x’ (Iₓ); value function for the probability ‘p’ of the information (Iₚ); value function for the lead-time ‘t’ of the information (Iₜ); adjust parameter (p), the construction of the Weather Decision Index (WDI) or Climate Decision Index (CDI) function, adopt the following assumptions:
the preferences of the probability ‘p’ and the lead-time ‘t’ are the same for any attribute ‘x’;
Iₚ or Iₜ=0→wdi or cdi=1;
Iₚ and Iₜ=1→wdi or cdi=Iₓ;
Iₚ and Iₜ=1, and Iₓ=0→wdi or cdi=0;
and wdi or cdi=f(Iₚ, Iₜ, Iₓ) for every attribute ‘x’, from the aggregation into a single value being defined the partial Weather Decision Index (WDI) or Climate Decision Index (CDI) function for each attribute, with weather-climate decision index (wdiₓ or cdiₓ) for attribute ‘x’ and adjustment parameter ρ=0.5 to be based on the equation:
wdiₓ or cdiₓ=Iₓ+(1−Iₓ)(1−(IₚIₜ)^{ρ}.

11. The method for decision-making support according to claim 7, characterized in that, in the sub-step of constructing weights among the attributes (205).

12. The method for decision-making support according to claim 7, characterized in that the value of the global WDI and/or CDI function is defined in the sub-step of the global Weather Decision Index (WDI) or global Climate Decision Index (CDI) (206), incorporating all the variables selected by the user, and considering the weather-climate information set ‘t’ the global WDI and/or CDI function is constructed from the comparison of the effects among the attributes and can be determined by:
$$DI ( t ) = {\sum }_{x = 1}^{n} {k}_{x} {di}_{x} ( t )$$
where diₓ(t) being the (partial) wdi and/or cdi value of each attribute ‘x’ in condition ‘t’ and kₓ being the attribute weight, being:
$${\sum }_{x = 1}^{n} {k}_{x} = 1$$
the global WDI and/or CDI function is an additive value function that determines the total values of each weather-climate condition, in which the recommended option for the user will be the alternative that obtains the numerical result according to the levels of warnings previously established and/or classification of decision alternatives.

13. The method for decision-making support according to claim 1, characterized in that Step 3 (103) is performed by parameterizing the Weather-Climate Decision Support System and comprises three sub-steps: a) Defining scenarios of unfavorable weather-climate events (207); b) Identification of levels for issuing warnings and selection of portfolios (208); c) Evaluation of performance in issuing warnings and selection of portfolios (209);
where,
at the sub-step of defining scenarios of unfavorable weather-climate events (207), the potential adverse/extreme weather-climate scenarios are identified and classified, and said scenarios are determined by varying the attributes values, based on the weather-climate hazard levels;
at the sub-step Identifying the classes for issuing warnings and selecting the portfolios (208), by using the variation of the attribute values and, respectively, the minimum and maximum WDIs or CDIs for each scenario, the respective values of the multi-attribute function for each level of warning and/or decision alternative are identified;
at the sub-step performance evaluation in the selection of warnings levels and portfolios (209) an evaluation of the results is performed employing a sensitivity analysis.

14. The method for decision-making support according to claim 1, characterized in that Step 4 (104) results and recommendations comprise the two types of possible operational results to be obtained: a) issuing warnings: classification and recommendation for issuing warnings by weather-climate information (105); and/or b) mitigation portfolios: classification and recommendation of mitigation actions by weather-climate information (106);
where,
the two types of operating results are dependent on the decision-making context using weather-climate information and the specific demands of stakeholders/users related to the problematic situation.

15. The method for decision-making support according to claim 1, characterized in that the in its general structure using Weather Decision Index (WDI) or Climate Decision Index (CDI), the information input (401) can be entered into the system by several categories of information being: real-time weather observations (402), weather forecast (403), seasonal climate prediction (404) and climate change forecast (405), from which information is evaluated values of the attributes and characteristics of the information (406) and individually transformed (407, 408 and 409) into a value function, from which said value values for each attribute are calculated the values of the partial WDI or CDI, by equation wdiₓ or cdiₓ=Iₓ+(1−Iₓ) (1−(Iₚ Iₜ)^{ρ}) and the previously established weather-climate scenarios ‘S’ (417) and the respective levels of warnings and/or decision alternatives (410, 411, 412 and 413) are also incorporated; from the partial IDM or IDC functions of each variable, the calculation of the multi-attribute WDI and/or CDI Function is performed using the equation: DI(t)=Σₓ₌₁ⁿkₓdiₓ(t) (414),
the results are being presented according to the user's preferences, being able to be a classification with different levels of warnings in case of adverse/extreme weather-climate conditions, by the recommendation in the issue warnings by category in the lead-time information (105) and/or the classification for action selection/mitigation portfolio, by the recommendation of mitigation actions in the lead-time of the weather-climate information (106).
